(19) United States
(12) Patent Application Publication
(10) Pub. No.: US 2015/0029402 A1
(43) Pub. Date: Jan. 29, 2015

(54) REMOTE CONTROLLER, SYSTEM, AND METHOD FOR CONTROLLING REMOTE CONTROLLER

(71) Applicant: TIANJIN FUNAYUANCHUANG TECHNOLOGY CO.,LTD., Tianjin (CN)

(72) Inventors: MING-YAO TSAI, HsinChu (TW); HO-CHIEN WU, New Taipei (TW)

(73) Assignee: TIANJIN FUNAYUANCHUANG TECHNOLOGY CO.,LTD., Tianjin (CN)

(21) Appl. No.: 14/191,463

(22) Filed: Feb. 27, 2014

(30) Foreign Application Priority Data
Jul. 26, 2013 (CN) 2013103185363

(51) Int. Cl. H04N 5/44

(52) U.S. Cl. CPC H04N 5/4403; H04N 2005/443; H04N 2005/4432
USPC 348/731

(57) ABSTRACT

A remote controller includes a touch module, a main processing unit, a communication module, and a motion sensing module. The touch module includes a touch panel and a touch signal processing unit. A method for controlling a remote controller includes steps of determining a switching behavior on the touch panel and switching the remote controller among operation modes corresponding to the switching behavior. The operation modes include a remoter mode, a touch-pad mode, and an air-mouse mode.

### CROSS-REFERENCE TO RELATED APPLICATIONS

This application claims all benefits accruing under 35 U.S.C. §119 from China Patent Application No. 201310318536.3, filed on Jul. 26, 2013 in the China Intellectual Property Office, the content of which is hereby incorporated by reference.

1. Field

The present disclosure relates to a remote controller, a system, and a control method for the remote controller.

2. Background

A display apparatus such as television can be remotely controlled by input through a remote controller. The remote controller transmits a control signal to the television using infrared signals to control the power, volume, and channel. Operation systems and programs for a variety of input interfaces can be installed directly in the television, which can be connected to the internet. However, inputting information through the conventional remote controller is difficult and complicated.

A conventional solution is adopting a portable device with the required input interface, such as a mobile phone having a touch panel, to be used as the remote controller. However, an adapting program must be installed in the portable device to control the television, and the compatibility or controllability between the portable device and the television may be low, decreasing the user experience.

What is needed, therefore, is to provide a remote controller, a system, and a control method for the remote controller, by which users can accomplish complicated input to the television.

### BRIEF DESCRIPTION OF THE DRAWING

Many aspects of the present disclosure can be better understood with reference to the following drawings. The components in the drawings are not necessarily to scale, the emphasis instead being placed upon clearly illustrating the principles of the present embodiments.

FIG. 1 is a schematic view of an embodiment of a remote controller.

FIG. 2 is a flowchart of an embodiment of a control method.

FIG. 3 is a schematic view of an embodiment of a remoter mode connection relationship of members in the remote controller.

FIG. 4 is a schematic view of an embodiment of a touch-pad mode connection relationship of members in the remote controller.

FIG. 5 is a schematic view of an embodiment of an air-mouse mode connection relationship of members in the remote controller.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean “at least one.”

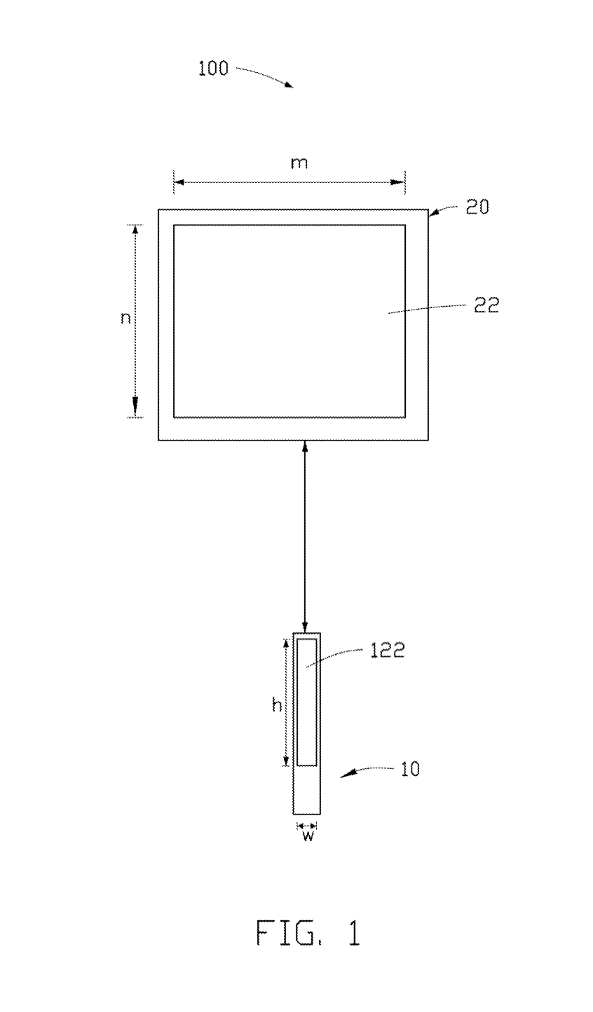

Referring to FIG. 1 and FIGS. 3-5, an embodiment of a system 100 includes a television 20 and a remote controller 10. The remote controller 10 includes a touch module 120, a main processing unit 110, a communication module 130, and a motion sensing module 140. The touch module 120 includes a touch panel 122 and a touch signal processing unit 124 (e.g., an integrated circuit (IC)). In one embodiment, the motion sensing module 140 is a gyroscope.

The main processing unit 110 can be a central processing unit (CPU) or a micro control unit (MCU). The communication module 130 includes an infrared transmission module 134 and/or a Bluetooth module 132. In other embodiments, the communication module 130 can also include a Wifi module. The remote controller 10 can further include a voice input module 150. In one embodiment, the voice input module 150 is a microphone.

When a user touches a touch point on the touch panel 122 of the touch module 120, the touch panel 122 senses a corresponding touch signal corresponding to the touch point. The touch signal processing unit 124 analyzes the touch signal and outputs a coordinate of the touch point on the touch panel 122. In one embodiment, the coordinate includes an X-coordinate and a Y-coordinate on an XY-plane. The remote controller 10 can also determine (or distinguish) a plurality of touch behaviors on the touch panel 122. In one embodiment, the touch panel 122 is a multipoint capacitance touch panel. The touch module 120 detects the touch behaviors by sensing a series of capacitance change values induced by the user's touch on the touch panel 122, and outputs the capacitance change values to the touch signal processing unit 124. The touch signal processing unit 124 processes the capacitance change values to calculate the coordinates of the touch points.

Each of the touch behaviors includes a position characteristic (e.g., where the touch occurs on the touch panel 122) and a time characteristic (e.g., how long the touch behavior occurs on the touch panel 122). A memory (not shown) of the remote controller 10 stores a plurality of position and time characteristics with respect to a plurality of predetermined behaviors. Once the position and time characteristics are determined from the series of touches, the specific behavior is determined.

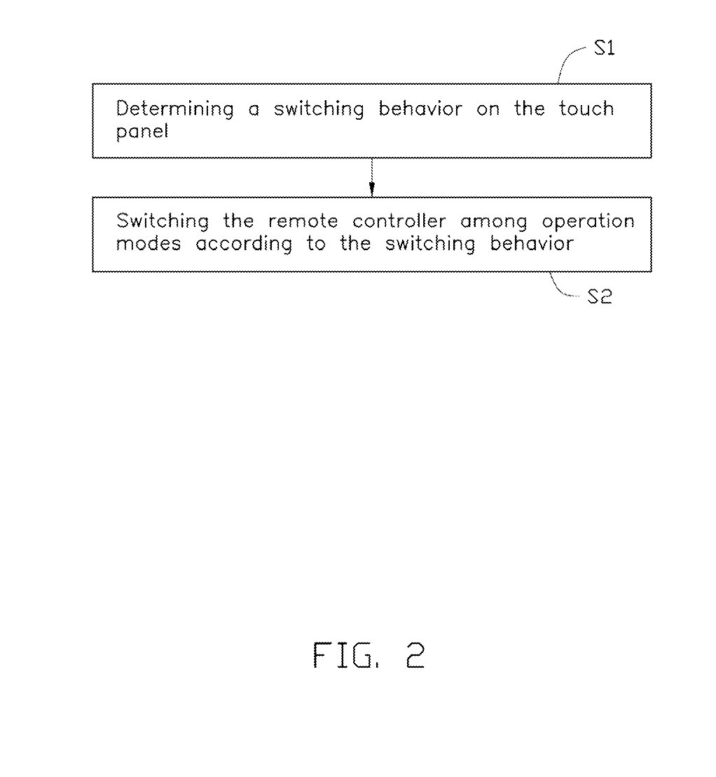

Referring to FIG. 2, an embodiment of a method for controlling the remote controller 10 includes the following steps:

S1: determining a switching behavior on the touch panel 122 for switching operation modes of the remote controller 10.

S2: switching the remote controller 10 among the operation modes according to the switching behavior. The operation modes include a remoter mode, a touch-pad mode, and an air-mouse mode.

In the remoter mode, the remote controller 10 is capable of adjusting a volume and changing a channel of the television 20, and turning on or turning off the television 20.

In the touch-pad mode, the remote controller 10 is capable of moving a mouse cursor displayed on the television screen 22, and controlling the mouse cursor to execute a mouse-click operation, according to touch operations on the touch panel 122.

In the air-mouse mode, the remote controller 10 is capable of moving the mouse cursor displayed on the television 20 according to spatial motions of the remote controller 10, and controlling the mouse cursor to execute the mouse-click operation according to the corresponding touch behavior on the touch panel 122.

In step 1, the touch panel 122 detects the touch operation on the touch panel 122. In one embodiment, one switching behavior is touching a first single fixed touch point on the touch panel 122 for X seconds (e.g., at a top of the touch panel 122 for 3 to 10 seconds). If the first single fixed touch point is touched for X seconds, the switching behavior is determined. In one embodiment, the operation modes are switched in a sequential order in response to the same switching behavior.

The determining step can be processed by the touch signal processing unit 124 or the main processing unit 110, depending where the determining program is stored.

In one embodiment, the touch signal processing unit 124 determines the switching behavior and outputs a switching command to the main processing unit 110. The main processing unit 110 switches the operation mode in response to receiving the switching command.

In another embodiment, the touch signal processing unit 124 outputs the coordinates and time characteristic of the touch points to the main processing unit 110. The main processing unit 110 determines the touch behaviors based on the touch points' position and time characteristics, and executes commands corresponding to the touch behaviors. For example, the main processing unit 110 determines the switching behavior and switches one operation mode to another in the predetermined order.

There are several pre-built programs corresponding to the operation modes in the main processing unit 110. Under different operation modes, the main processing unit 110 executes the corresponding programs to complete different functions and output different signals from the remote controller 10. The signals are wirelessly transmitted to the television 20.

In the remoter mode, the remote controller 10 is capable of detecting a volume-up behavior, a volume-down behavior, a channel-up behavior, a channel-down behavior, and a power on/off behavior on the touch panel 122, and correspondingly transmitting a volume-up signal, a volume-down signal, a channel-up signal, a channel-down signal, and a power on/off signal to a television 20.

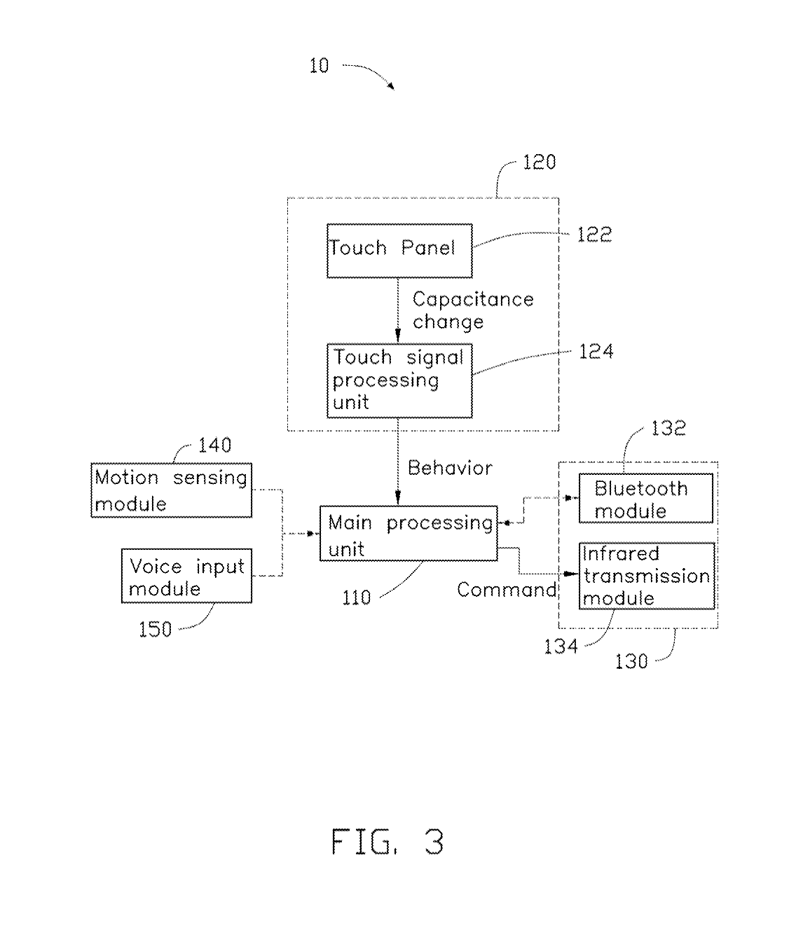

Referring to FIG. 3, under the remoter mode, the method can further include the following steps:

S21, determining a remote controlling behavior on the touch panel 122, the remote controlling behavior includes one of a volume-up behavior, a volume-down behavior, a channel-up behavior, a channel-down behavior, and a power on/off behavior; and

S31, transmitting one of a volume-up signal, a volume-down signal, a channel-up signal, a channel-down signal, and a power on/off signal to a television 20, according to the remote controlling behavior.

Under the remoter mode, the remote controller 10 can also perform functions and transmit signals as a conventional remote controller. The touch signal processing unit 124 or the main processing unit 110 determines remote controlling behaviors on the touch panel 122. The communication module 130 transmits the volume-up, volume-down, channel-up, channel-down signals, and the power on/off signal according to the remote controlling behaviors to the television The remote controlling behavior includes a volume-up behavior, a volume-down behavior, a channel-up behavior, a channel-down behavior, and a power on/off behavior. The most commonly used signals in the communication between the remote controller 10 and the television 20 is the infrared signals. Thus, under the remoter mode, the infrared signals which can be recognized by the television 20 are transmitted.

In one embodiment, the volume-up behavior, volume-down behavior, channel-up behavior, and channel-down behavior are straight touch traces of the user's finger sliding on the touch panel 122 toward a predetermined direction. For example, the volume-up behavior is a touch trace from a position on the touch panel 122 toward a first direction (e.g., a right direction), the volume-down behavior is a touch trace from a position on the touch panel 122 toward a second direction (e.g., a left direction), the channel-up behavior is a touch trace from a position on the touch panel 122 toward a third direction (e.g., an up direction), and the channel-down behavior is a touch trace from a position on the touch panel 122 toward a fourth direction (e.g., a down direction). The first, second, third, and fourth directions being different directions. When the touch signal processing unit 124 determines one trace of the touch point along the right, left, up or down direction, one corresponding volume-up, volume-down, channel-up, or channel-down command is outputted to the main processing unit 110. The power on/off behavior can be a zigzag shaped trace on the touch panel 122. When the touch signal processing unit 124 determines the zigzag trace on the touch panel 122, the corresponding power on/off command is outputted to the main processing unit 110. In other embodiments, the behaviors can be other gestures defined by the user.

The main processing unit 110 transmits the volume-up, volume-down, channel-up, channel-down, and the power on/off signals according to the volume-up, volume-down, channel-up, channel-down, and power on/off commands through the infrared transmission module 134.

Under the touch-pad mode, the remote controller 10 is capable of detecting a touch point and determining a mouse-click behavior on the touch panel 122 and correspondingly transmitting a coordinate of a mouse cursor calculated from a coordinate of the touch point and a mouse-click signal to the television 20.

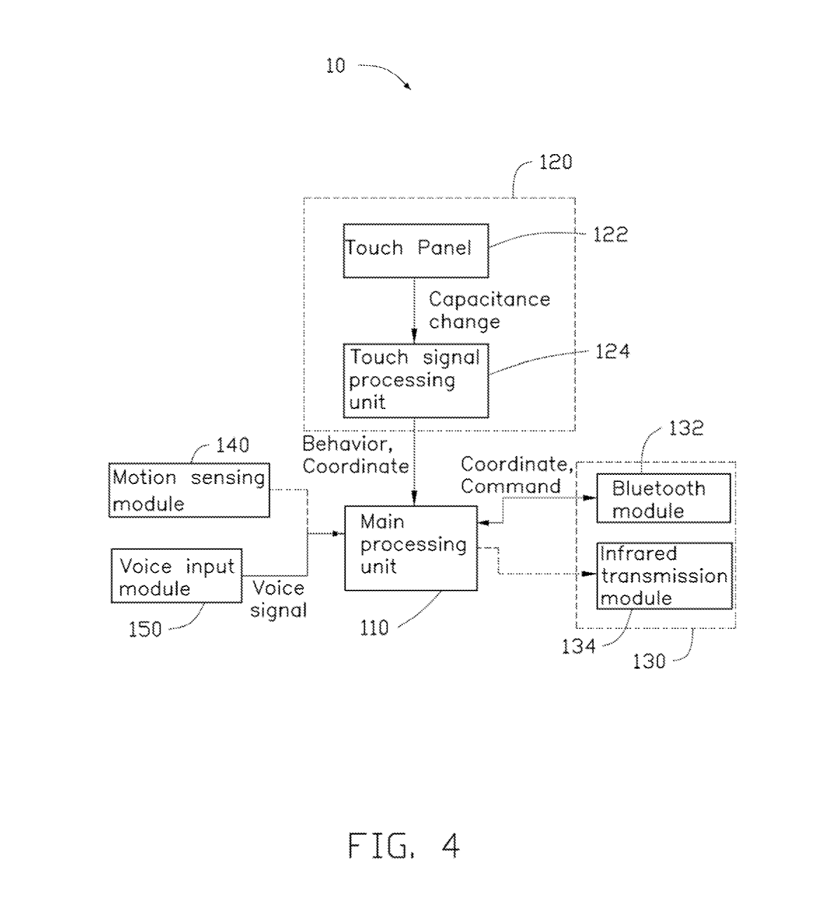

Referring to FIG. 4, under the touch-pad mode, the method can further include:

S22, detecting a touch point and determining a mouse-click behavior on the touch panel 122; and

S32, correspondingly transmitting a coordinate of a mouse cursor calculated from a coordinate of the touch point, and a mouse-click signal to the television 20.

Under the touch-pad mode, the remote controller 10 completes a touch-pad function and controls the mouse cursor displayed by the television 20. The touch signal processing unit 124 detects a touch point on the touch panel 122 and outputs a coordinate of the touch point. The touch signal processing unit 124 or the main processing unit 110 determines a mouse-click behavior on the touch panel 122 based on the coordinate of the touch point and calculates a coordinate of a mouse cursor to be shown on the television screen 22 from the coordinate of the touch point. The communication module 130 transmits the coordinate of a mouse cursor and the mouse-click signal to the television 20.

In one embodiment, the remote controller 10 has a bar shape with a long and thin touch panel 122 thereon. In one embodiment, a width of the long and thin touch panel 122 corresponds to a width of the television screen 22, and a length of the long and thin touch panel 122 corresponds to a height of the television screen 22. However, the width of the television screen 22 can be larger than the height. Thus, if the coordinate of the touch point is directly used as the coordinate of the mouse cursor, moving speeds of the mouse cursor along a width direction and length direction on the screen 22 can be different.

In one embodiment, the method further includes a step of calculating the coordinate of the mouse cursor from the coordinate of the touch point. More specifically, the long and thin touch panel 122 has a length of h and a width of w, and the television screen 22 has a height of n and width of m. If a touch point moves a distance of h along the length direction of the touch panel 122 (i.e., from one end to the other end), then the mouse cursor moves a distance of n along the height direction. However, if a touch point moves a distance of w along the width direction of the touch panel 122, the mouse cursor does not move a distance of m, but w*n/h along the width direction to compensate for the size difference. The coordinate of the mouse cursor can be determined using the equations: ΔY1=ΔX1·n/h and ΔY2=ΔX2·n/h, wherein ΔY1 is a moving distance of the mouse cursor along the height direction on the screen 22, ΔY2 is a moving distance of the mouse cursor along the width direction on the screen 22, ΔX1 is a moving distance of the touch point along the length direction of the touch panel 122, and ΔX2 is a moving distance of the touch point along the width direction of the touch panel 122. The coordinate of the mouse cursor can be calculated by the program in the touch signal processing unit 124 or the main processing unit 110. In one embodiment, the touch signal processing unit 124 calculates the coordinates of the mouse cursor and outputs the coordinates to the main processing unit 110.

In one embodiment, the mouse-click behavior can be a short touch operation of the finger on a second fixed position of the touch panel 122. The short touch operation can be a touch on the second fixed position of the touch panel 122 persisting only for a short period of time of Y seconds (e.g., 0.3 to 0.5 seconds). Once a touch point is detected on the touch panel 122 which satisfies the position characteristic, in the determining step, the lasting time for the touch point is determined to satisfy the time characteristic. When the touch signal processing unit 124 determines a touch point occurring on the second fixed position for Y seconds and disappears, a corresponding mouse-click command is outputted to the main processing unit 110. The second fixed position can be anywhere on the touch panel 122.

The main processing unit 110 transmits the mouse-click signal corresponding to the mouse-click command through the infrared transmission module 134, Bluetooth module 132, or WIFI module.

The method can include a step S12′ of receiving a voice input through a microphone (not shown) and analyzing the voice by the voice input module 150. The step S12′ can be processed simultaneously with the step S1. Thus, the voice input and the touch input can be processed simultaneously.

When the signals are transmitted through the Bluetooth module 132, the method can further include steps of:

S22′, determining a Bluetooth-connecting behavior on the touch panel 122; and

S32′, correspondingly transmitting a Bluetooth-connecting signal to the television 20.

The touch signal processing unit 124 or the main processing unit 110 determines the Bluetooth-connecting behavior on the touch panel 122. The communication module 130 transmits the Bluetooth-connecting signal to the television 20.

In one embodiment, the Bluetooth-connecting behavior can be a sustained touch of the finger on a third fixed position (e.g., at a bottom) of the touch panel 122 for Z seconds. Thus, once a touch point is detected on the third fixed position which satisfies the position characteristic, the lasting time for the touch point is to be determined to satisfy the time characteristic. If the touch point on the fixed position is detected for lasting Z seconds on the third fixed position, the Bluetooth-connecting behavior is determined, and the Bluetooth-connecting signal is transmitted to the television 20 to connect the remote controller 10 and the television 20 through Bluetooth. The Bluetooth-connecting signal can be transmitted through the infrared transmission module 134 or the WIFI module.

Under the air-mouse mode, the remote controller 10 is capable of determining a mouse-click behavior on the touch panel 122, and transmitting a signal according to the spatial motion, and a mouse-click signal to the television 20.

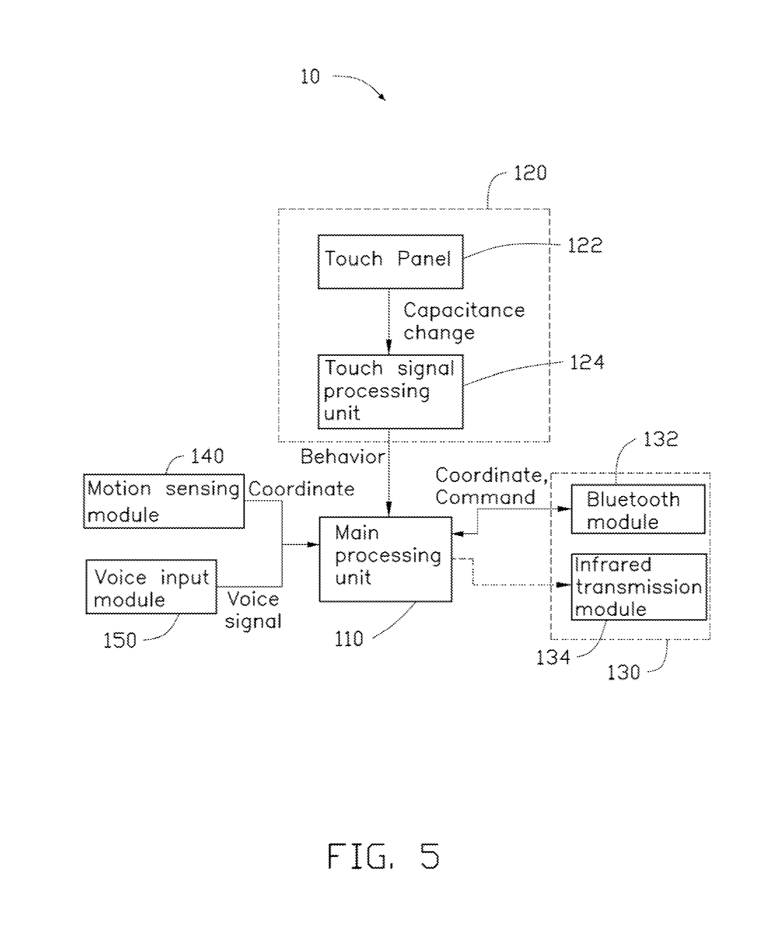

Referring to FIG. 5, under the air-mouse mode, the method can further include:

S13, detecting a motion of the remote controller 10;

S23, determining a mouse-click behavior on the touch panel 122; and

S33, correspondingly transmitting a coordinate of a mouse cursor according to the motion of the remote controller 10 and a mouse-click signal to the television 20.

By using the motion sensing module 140 such as the gyroscope, a motion of the remote controller 10 can be detected. An electrical output of the motion sensing module 140 corresponding to the motion can be converted into a format usable for the main processing unit 110 to output the coordinate of the mouse cursor.

The step S23 can be the same as the step S22. The mouse-click behavior can be a short touch operation of the finger on the second fixed position of the touch panel 122 for Y seconds. Under the air-mouse mode, the mouse-click behavior can improve the accuracy of the input of the remote controller 10. The coordinate of the mouse cursor depends on the motion of the remote controller 10. If the user touches the touch panel 122 to input the mouse-click behavior, the remote controller 10 could shake, which affects the position of the mouse cursor on the television screen 22. Thus, the accuracy of the coordinate of the mouse cursor is affected. By setting the mouse-click behavior as a short touch operation of the finger on a second fixed position on the touch panel 122, the user can manipulate the accuracy of the position of the mouse cursor on the television screen 22. If the mouse cursor is in a wrong position, the user can cancel the mouse-click action by touching the touch panel 122 longer than Y seconds (i.e., not releasing the touch in time).

Further, the method may include a step S13′ of receiving a voice by the microphone and analyzing the voice by the voice input module 150. Step S13′ can be processed simultaneously with step S1. Thus, the voice input and the touch input can be processed simultaneously.

When the signals are transmitted through the Bluetooth module 132, the method can further include steps of:

S23′, determining a Bluetooth-connecting behavior on the touch panel 122; and

S33′, correspondingly transmitting a Bluetooth-connecting signal to the television 20.

The remote controller 10 has at least three operation modes and can switch among the operation modes by inputting a switching behavior, which is simple and convenient for the user to carry out various functions of the remote controller 10 (e.g., volume and channel changes and power on/off) by touch and motion sensing functions in one remote controller 10.

Depending on the embodiment, certain steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

Finally, it is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

What is claimed is:

1. A method for controlling a remote controller for a television, the remote controller comprising a touch module, a main processing unit, a communication module, and a motion sensing module, the touch module comprising a touch panel and a touch signal processing unit, the method comprising:
determining a switching behavior on the touch panel; and
switching the remote controller among operation modes corresponding to the switching behavior, the operation modes comprising:
a remoter mode, wherein the remote controller detects a volume-up behavior, a volume-down behavior, a channel-up behavior, a channel-down behavior, and a power on/off behavior on the touch panel, and transmits a volume-up signal, a volume-down signal, a channel-up signal, a channel-down signal, and a power on/off signal to the television;
a touch-pad mode, wherein the remote controller detects a touch point and determines a mouse-click behavior on the touch panel and transmits a coordinate of a mouse cursor calculated from a coordinate of the touch point and a mouse-click signal to the television; and
an air-mouse mode, wherein the remote controller detects a spatial motion of the remote controller, determines a mouse-click behavior on the touch panel, and transmits a signal corresponding to the spatial motion, and a mouse-click signal to the television.

2. The method of claim 1, wherein the touch panel senses a capacitance change value and outputs the capacitance change value to the touch signal processing unit.

3. The method of claim 1, wherein the determining is processed by the touch signal processing unit.

4. The method of claim 1, wherein the determining is processed by the main processing unit.

5. The method of claim 1, wherein the switching behavior is a sustained touch on a first fixed position.

6. The method of claim 1, wherein a duration of the sustained touch on the first fixed position is 3 to 10 seconds.

7. The method of claim 1, wherein under the remoter mode, the method further comprises:
determining a remote controlling behavior on the touch panel, the remote controlling behavior comprising one of the volume-up behavior, the volume-down behavior, the channel-up behavior, the channel-down behavior, and the power on/off behavior; and
transmitting one of the volume-up signal, the volume-down signal, the channel-up signal, the channel-down signal, and the power on/off signal corresponding to the remote controlling behavior to the television.

8. The method of claim 1, wherein the volume-up behavior, volume-down behavior, channel-up behavior, and channel-down behavior are straight slides of the finger on the touch panel, the volume-up behavior is a straight slide toward a first direction, the volume-down behavior is a straight slide toward a second direction, the channel-up behavior is a straight slide toward a third direction, and the channel-down behavior is a straight slide toward a fourth direction, the first, second, third, and fourth directions being different directions.

9. The method of claim 1, wherein under the touch-pad mode, the method further comprises:
detecting a touch point and determining a mouse-click behavior on the touch panel; and
transmitting a coordinate of a mouse cursor calculated from a coordinate of the touch point and a mouse-click signal to the television.

10. The method of claim 9, wherein the coordinate of the mouse cursor is satisfied by the equations of ΔY1=ΔX1·n/h and ΔY2=ΔX2·n/h, wherein ΔY1 is a move distance of the mouse cursor along a height direction on a screen of the television, ΔY2 is a movement distance of the mouse cursor along a width direction on the screen, ΔX1 is a movement distance of the touch point along a length direction of the touch panel, and ΔX2 is a movement distance of the touch point along a width direction of the touch panel, n is a height of a television screen, and h is a length of the touch panel.

11. The method of claim 1, wherein under the air-mouse mode, the method further comprises:
detecting a motion of the remote controller;
determining a mouse-click behavior on the touch panel; and
transmitting a coordinate of a mouse cursor corresponding to the motion of the remote controller and a mouse-click signal to the television.

12. The method of claim 1, wherein the mouse-click behavior is a short touch of the finger on a second fixed position of the touch panel, and the short touch is a persisting touch on the second fixed position of the touch panel.

13. The method of claim 12, wherein a duration of the persisting touch is 0.3 to 0.5 seconds.

14. A remote controller for a television, the remote controller comprising a touch module, a main processing unit, a communication module, and a motion sensing module, the touch module comprising a touch panel and a touch signal processing unit, the main processing unit being configured for switching the remote controller among operation modes corresponding to a switching behavior, the operation modes comprising:
a remoter mode, wherein the remote controller detects a volume-up behavior, a volume-down behavior, a channel-up behavior, a channel-down behavior, and a power on/off behavior on the touch panel, and transmits a volume-up signal, a volume-down signal, a channel-up signal, a channel-down signal, and a power on/off signal to the television;
a touch-pad mode, wherein the remote controller detects a touch point and determines a mouse-click behavior on the touch panel and transmits a coordinate of a mouse cursor calculated from a coordinate of the touch point and a mouse-click signal to the television; and
an air-mouse mode, wherein the remote controller detects a spatial motion of the remote controller, determines a mouse-click behavior on the touch panel, and transmits a signal corresponding to the spatial motion, and a mouse-click signal to the television.

15. A system comprising a remote controller and a television, the remote controller comprising a touch module, a main processing unit, a communication module, and a motion sensing module, the touch module comprising a touch panel and a touch signal processing unit, the main processing unit being configured for switching the remote controller among operation modes corresponding to a switching behavior, the operation modes comprising:
a remoter mode, wherein the remote controller detects a volume-up behavior, a volume-down behavior, a channel-up behavior, a channel-down behavior, and a power on/off behavior on the touch panel and transmits a volume-up signal, a volume-down signal, a channel-up signal, a channel-down signal, and a power on/off signal to the television;
a touch-pad mode, wherein the remote controller detects a touch point and determines a mouse-click behavior on the touch panel and transmits a coordinate of a mouse cursor calculated from a coordinate of the touch point and a mouse-click signal to the television; and
an air-mouse mode, wherein the remote controller detects a spatial motion of the remote controller, determines a mouse-click behavior on the touch panel, and transmits a signal corresponding to the spatial motion, and a mouse-click signal to the television.
